(19) United States
(12) Patent Application Publication
(10) Pub. No.: US 2026/0237761 A1
(43) Pub. Date: Aug. 13, 2026

(54) BATTERY PACK, METHOD OF MAKING THE BATTERY PACK AND ENERGY STORAGE SYSTEM UNIT INCLUDING THE BATTERY PACK

(71) Applicant: Samsar Resources, LLC, New York, NY (US)

(72) Inventors: Guillermo GARCIA, Oakland, CA (US); Arvind Kumar PEEHAL, Bengaluru (IN); Andrew MALEK, New York, NY (US); Ross PETERS, New York, NY (US); Harshwardhan WADIKAR, San Jose, CA (US)

(21) Appl. No.: 19/154,239

(22) PCT Filed: Feb. 23, 2024
(86) PCT No.: PCT/US2024/016991

§ 371 Date: Aug. 6, 2025

(30) Foreign Application Priority Data
Feb. 23, 2023 (IN) 202341012424

(51) Int. Cl. H01M 10/42; H01M 10/48; H01M 50/262; H01M 50/583; H02J 7/80

(52) U.S. Cl. CPC H01M 10/425; H01M 10/482; H01M 10/486; H01M 50/262; H01M 50/583; H01M 2010/4271; H01M 2200/103; H02J 7/80

(57) ABSTRACT

A battery pack includes a battery pack housing, a plurality of energy storage devices of a plurality of different types located in the battery pack housing, and a battery management system (BMS) unit electrically coupled to the plurality of energy storage devices and configured to manage an operation of the plurality of energy storage devices.

### RELATED APPLICATIONS

The present application claims the benefit of priority from India Provisional Application No. 202341012424, filed Feb. 23, 2023, the entire contents of which are incorporated herein by reference.

### FIELD

The present invention relates to a battery pack, a method of making the battery pack and an energy storage system unit including the battery pack.

### BACKGROUND

An energy storage system (ESS), such as a residential ESS, may store excess energy generated by one or more energy sources (e.g., renewable energy sources, such as solar panels) for later use. The stored energy can be used during periods of high energy demand or when the energy sources are not producing enough power.

The ESS may include, for example, a battery pack, an inverter, and an ESS controller (e.g., management system) to control the flow of energy. The battery pack may store the energy, the inverter may convert the stored energy from direct current (DC) to alternating current (AC) (e.g., for use in the residence), and the ESS controller may control the charging and discharging of the battery pack.

### SUMMARY

According to an aspect of the present disclosure, a battery pack includes a battery pack housing, a plurality of energy storage devices of a plurality of different types located in the battery pack housing, a battery management system (BMS) unit electrically coupled to the plurality of energy storage devices and configured to manage an operation of the plurality of energy storage devices.

According to another aspect of the present disclosure, an energy storage system (ESS) unit includes an ESS unit housing, a battery pack in the ESS unit housing, including a battery pack housing, a plurality of energy storage devices of a plurality of different types located in the battery pack housing, and a battery management system (BMS) unit electrically coupled to the plurality of energy storage devices and configured to manage an operation of the plurality of energy storage devices, and an ESS controller communicatively coupled to the BMS unit of the battery pack and configured to control an operation of the ESS unit.

According to another aspect of the present disclosure, a method of replacing a battery pack in an energy storage system (ESS) unit, the method including providing an ESS unit including an ESS unit bracket set to a first setting to accommodate a first battery pack having a first size, a first shape and a first orientation, removing the first battery pack from the ESS unit, inserting a second battery pack into the ESS unit, wherein the second battery pack includes at least one of a second size different than the first size, a second shape different than the first shape, or a second orientation different than the first orientation, and adjusting the ESS unit bracket from the first setting to a second setting different than the first setting to accommodate the second battery pack.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1A is a vertical cross-sectional view of a battery cell according to one or more embodiments.

FIG. 1B is a vertical cross-sectional view of a battery cell stack according to one or more embodiments.

FIG. 1C is a vertical cross-sectional view of a battery module according to one or more embodiments.

FIG. 2A is a plan view of the battery pack having the first design according to one or more embodiments.

FIG. 2B is a schematic view of the BMS unit in the battery pack having the first design according to one or more embodiments.

FIG. 2C is a plan view of a battery pack bracket in the battery pack having the first design according to one or more embodiments.

FIG. 3A is a plan view of the battery pack having the second design according to one or more embodiments.

FIG. 3B is a schematic view of the BMS unit in the battery pack having the second design according to one or more embodiments.

FIG. 3C is a plan view of a battery pack bracket in the battery pack having the second design according to one or more embodiments.

FIG. 4 is a flow chart illustrating a method of replacing an energy storage device (e.g., battery cell stack, battery module, etc.) in the battery pack according to one or more embodiments.

FIG. 5 is a schematic illustration of an energy storage system (ESS) according to one or more embodiments.

FIG. 6 is a vertical cross-sectional view of the ESS unit according to one or more embodiments.

FIG. 7 is a schematic illustration of the ESS controller according to one or more embodiments.

FIG. 8 is a plan view of the ESS unit bracket in the ESS unit according to one or more embodiments.

FIG. 9 is a flow chart illustrating a method of replacing the battery pack in the ESS unit, according to one or more embodiments.

### DETAILED DESCRIPTION

As discussed above, the embodiments of the present disclosure are directed to a battery pack, a method of making the battery pack and an energy storage system unit including the battery pack, the various aspects of which are discussed herein in detail. The drawings are not necessarily drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure.

The same reference numerals refer to the same element or similar element. Unless otherwise indicated, elements having the same reference numerals are presumed to have the same composition. As used herein, a first element located “on” a second element can be located on the exterior side of a surface of the second element or on the interior side of the second element. As used herein, a first element is located “directly on” a second element if there exist a physical contact between a surface of the first element and a surface of the second element. As used herein, a “layer” refers to a continuous portion of at least one material including a region having a thickness. A layer may consist of a single material portion having a homogeneous composition, or may include multiple material portions having different compositions.

One or more embodiments of the present disclosure may include a battery pack (e.g., energy storage system (ESS) battery pack) and an energy storage system unit (e.g., ESS unit) that may include the battery pack. The battery pack may include, for example, a battery pack housing (e.g., independent IP67 rated enclosure and/or NEMA type 3R rated enclosure which is resistant to ingress of water, rain, ice formation, sleet and snow) and battery cells and/or battery modules containing the battery cells housed in the battery pack housing. In at least one embodiment, the battery pack may include a range of battery cells (e.g., 1 to 500 battery cells) connected in a series and/or a parallel configuration. The battery pack may also include wiring, terminals and a battery management system (BMS) unit for managing an operation of the battery pack.

The battery pack may include a new (e.g., unused) battery pack including new battery cells and/or new battery modules. Alternatively or in addition, the battery pack may also include a repurposed battery pack including repurposed battery cells and/or repurposed battery modules instead of or in additional to the new battery cells and/or modules. The battery pack may provide a convenient use of repurposed battery cells and repurposed battery modules. The battery pack may include various elements such as interconnectivity, monitoring, placement, wiring and safety that may be important for utilizing a variety of new and/or used battery cells and battery modules.

A composition of the battery pack and/or its elements may include, for example, a single cell composition (i.e., where all cells in the battery pack are the same), mixed cell composition (i.e., where the cells in the battery pack are different from each other, such as new and repurposed cells, or repurposed cells from different prior uses, or cells having different chemistries of electrodes and/or electrolytes), single module composition (i.e., where all modules are the same) and/or mixed module composition (i.e., where the modules are different from each other, such as new and repurposed modules, or repurposed modules from different prior uses, or modules having cells with different chemistries of electrodes and/or electrolytes). The battery pack may provide multiple battery cell/battery module configurations while maintaining a safe operation. A placement of the BMS unit within the battery pack may vary depending on the type of cell/module composition and orientation.

The BMS unit may be designed to balance and power each type of composition/ configuration of the battery cells and/or battery modules in the battery pack. The BMS unit may closely monitor and manage the voltage/safety limits set by the application. In the case of a mixed battery cell/mixed battery module composition, individual limits may be set for varying chemistries by the BMS unit. In at least one embodiment, the battery pack may include more than one BMS unit. In at least one embodiment, each battery module in the battery pack may include a battery module BMS unit working in cooperation with the battery pack BMS unit (e.g., in a slave-master relationship).

Compatibility of the BMS unit with a variety of hybrid inverters in the market may allow for user control of charging via grid or solar power as well as back-up load power to key components within the built environment. BMS unit architecture and wiring schematics for the battery pack may also create simple standardization for ultimate flexibility.

The battery pack may also include a battery pack bracket. The battery pack bracket may be used to secure the battery cells and/or the battery modules in battery pack housing. In at least one embodiment, the battery pack bracket may assist with physical placement of the different battery cell compositions, different battery module compositions, different battery cell orientations and different battery module orientations. In at least one embodiment, the battery pack bracket may include an adjustable locking mechanism that can accurately and precisely orient varying shapes and sizes of the cells/modules.

The ESS unit may include a residential ESS unit for powering a residential structure or a commercial ESS unit for powering a commercial structure. The ESS unit may include for example, an ESS unit housing (e.g., NEMA 3R rated) for environmental/ structural purposes. The ESS unit may also include electrical relays and electrical fuses, wiring, a temperature control system (e.g., fans, sensors, etc.) for controlling, monitoring and/or venting the ESS unit housing, and a telematics unit (e.g., communication unit, communication board, etc.).

The ESS unit may also include an ESS unit bracket (e.g., locking lever) for fixing a position and/or orientation of the battery pack in the ESS unit housing. In at least one embodiment, the ESS unit bracket may assist with physical placement of the battery pack in the ESS unit housing. In at least one embodiment, the ESS unit bracket may include an adjustable ESS unit bracket (e.g., adjustable locking lever or adjustable locking mechanism) that may orient varying shapes, sizes and/or orientations of battery packs accurately and precisely.

In one embodiment, the battery pack may include of one or more types of battery cells/battery modules (e.g., mixed battery cells/battery modules). The battery pack may the monitor and/or track performance of the battery cells and battery modules. In particular, the battery pack may include different repurposed cell compositions, and may provide tracking, monitoring and management of the different repurposed cell compositions. The battery pack may therefore, facilitate the adoption of repurposed used cells and create a technical pathway to ensure safety, compatibility, and simplicity thereof.

The battery pack and ESS unit housing configuration may also cooperate to provide fast and effective interconnectivity of the battery pack in the ESS unit housing. The battery pack and ESS unit configuration may also provide a capability for swapping battery packs at any given time when a battery pack no longer meets the application requirement.

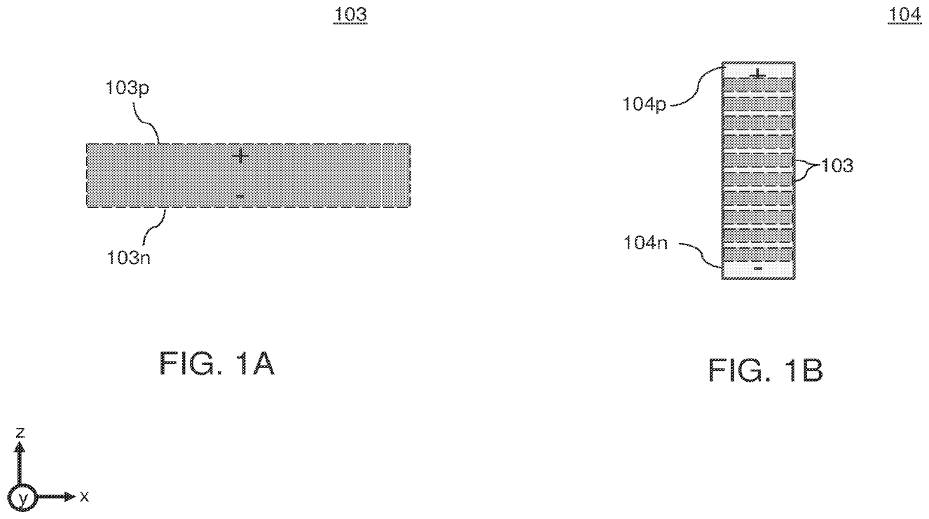

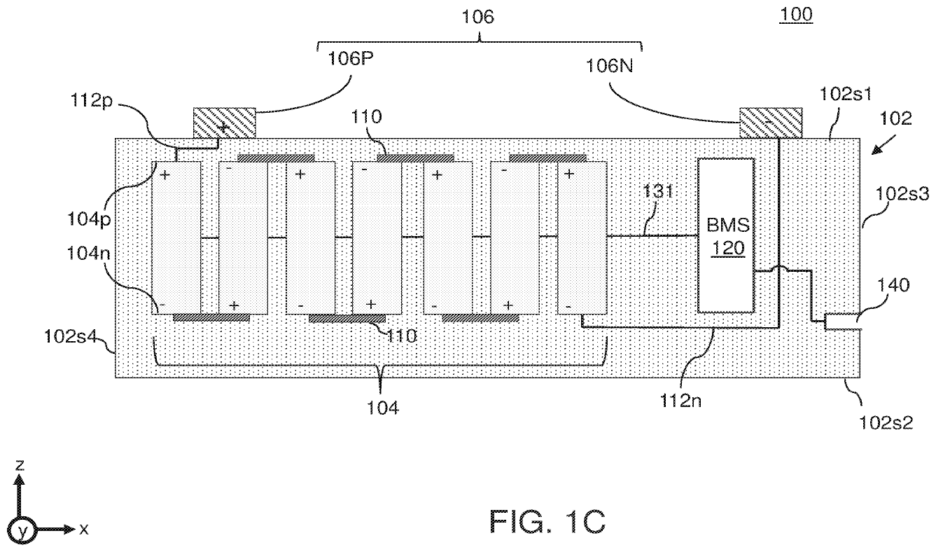

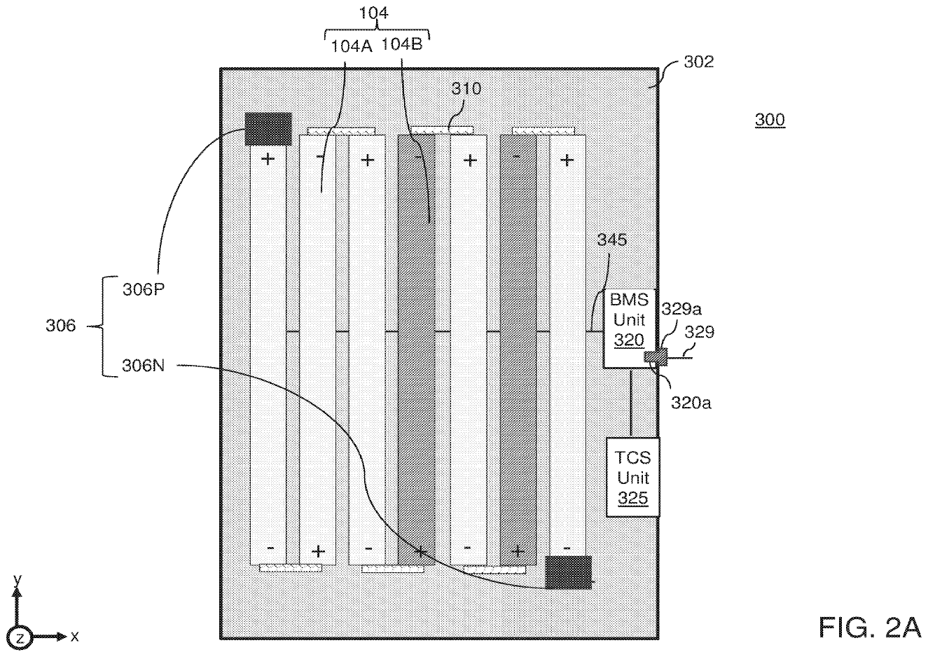

FIGS. 1A-1C are vertical cross-sectional views of energy storage devices according to one more embodiments. In particular, FIG. 1A is a vertical cross-sectional view of a battery cell 103 according to one or more embodiments. FIG. 1B is a vertical cross-sectional view of a battery cell stack 104 according to one or more embodiments. FIG. 1C is a vertical cross-sectional view of a battery module 100 according to one or more embodiments. Each of the battery cell 103, the battery cell stack 104 and the battery module 100 may be referred to as an energy storage device.

The battery cell 103 (e.g., electrochemical cell) in FIG. 1A may include any type of energy storage device that may store chemical energy and convert it to electrical energy (e.g., electrical current). The battery cell 103 may include a positive end 103p having a positive battery cell terminal coupled to a positive (e.g., cathode) electrode, a negative end 103n having a negative battery cell terminal coupled to a negative (e.g., anode) electrode, and an electrolyte with an optional separator between the electrodes. The battery cell 103 may be a secondary (e.g., rechargeable) battery cell. In at least one embodiment, the battery cell 103 may include a lithium ion battery cell (e.g., a lithium iron phosphate cell, lithium cobalt oxide cell, lithium manganese oxide cell, lithium nickel manganese cobalt oxide cell, lithium nickel cobalt aluminum oxide cell, lithium titanate cell, etc.), a nickel cadmium battery cell, and/or a nickel metal hydride battery cell. The battery cell 103 may commonly be configured, for example, as a pouch cell, a cylindrical cell or a prismatic cell. Other types of battery cells 103 (e.g., other types of chemical compositions) are within the contemplated scope of disclosure. For example, instead of cells having ion insertion (i.e., intercalation) type anode and cathode electrodes, the cells may comprise hybrid cell stacks having one intercalation electrode (e.g., cathode) and one non ion insertion type (e.g., double layer capacitor type) electrode (e.g., anode). Alternatively, the cells may have two non-ion insertion electrodes (e.g., supercapacitor type cell stacks).

The battery cell stack 104 in FIG. 1B may include one or more battery cells 103 stacked (e.g., in the z-direction) on each other. The battery cell stack 104 may include a positive end 104p having a positive battery cell stack terminal (not shown) and a negative end 104n having a negative battery cell stack terminal (not shown). In the battery cell stack 104, the battery cells 103 may be electrically connected in series (as shown in FIG. 1A) and/or in parallel. In at least one embodiment, the battery cells 103 may be stacked in a series arrangement in which the positive battery cell terminal 103P of a battery cell 103 contacts a negative battery cell terminal 103n of an overlying battery cell 103. Other configurations of the battery cell stack 104 are within the contemplated scope of disclosure.

As illustrated in FIG. 1C, the battery module 100 may include a battery module housing 102 and a plurality of battery cell stacks 104 in the battery module housing 102. The battery module 100 may also include terminals 106 (e.g., external terminals) connected to the battery cells stacks 104. The terminals 106 may include one or more positive terminals 106P located on a first side 102s1 of the battery module housing 102 and electrically coupled to a positive end of the plurality of battery cell stacks 104 (e.g., to the battery cells 103). The terminals 106 may also include one or more negative terminals 106N located on the first side 102s1 of the battery module housing 102 and electrically coupled to a negative end of the plurality of battery cell stacks 104 (e.g., to the battery cells 103). The positive terminal 106P and negative terminal 106N may have a “male” configuration projecting out of the first side 102s1 of the battery module housing 102.

The negative terminal 106N may alternatively be formed on a second side 102s2 of the battery module housing 102 (opposite the first side 102s1) and have a “female” configuration projecting into the second side 102s2. This design may allow the battery module 100 to be conveniently stacked together one or more other battery modules in a series arrangement. In that case, the negative terminal 106N may be substantially aligned (in the z-direction) with the positive terminal 106P, so that the positive terminal 106P may be inserted into the negative terminal 106N in the series arrangement.

Although the battery module 100 is illustrated with one positive terminal 106P and one negative terminal 106N, any number of positive terminals 106P and negative terminals 106N may be included in the battery module 100. The positive terminal 106P may have the same shape or different shape as the negative terminal 106N.

The positive terminal 106P and negative terminal 106N may include one or more layers of conductive material. The positive terminal 106P and negative terminal 106N may have a cylindrical shape, such as a circular cylindrical shape, square cylindrical shape, etc.

The positive terminal 106P and negative terminal 106N may be connected to the battery module housing 102, such as by a fastener (e.g., screw), soldering, welding, etc.

The positive terminal 106P and negative terminal 106N may include the same materials. The positive terminal 106P and negative terminal 106N may include one or more layers of metal or metal alloy. In at least one embodiment, the positive terminal 106P and negative terminal 106N may include copper, lead, or alloys of copper or lead. Other materials may be within the contemplated scope of disclosure.

The battery module housing 102 may include, for example, a substantially hollow cuboid shape having six sidewalls. The six sidewalls may include the first sidewall 102s1 and the second sidewall 102s2. The six sidewalls may also include a third sidewall 102s3 and a fourth sidewall 102s4 opposite the third sidewall 102s3, that connect the first sidewall 102s1 to the second sidewall 102s2. The six sidewalls may also include a fifth sidewall (in front of the plane of FIG. 1C, not shown) and a sixth sidewall (behind the plane of FIG. 1C, not shown) opposite the fifth sidewall. The fifth sidewall and sixth sidewall may connect the first sidewall 102s1 to the second sidewall 102s2 and connect the third sidewall 102s3 to the fourth sidewall 102s4. Other shapes of the battery module housing 102 are within the contemplated scope of disclosure.

The battery module housing 102 may be divided into two separate sections to allow access to an interior of the battery module housing 102. The two sections may include, for example, an upper section including the first sidewall 102s1 and a lower section including the second sidewall 102s2. In at least one embodiment, the two separate sections may be connected by a connecting structure (not shown), such as a hinge. In at least one embodiment, the battery module housing 102 may include a box-shaped case body (lower section) having a lid (upper section) that opens upward.

The six sidewalls of the battery module housing 102 may be formed, for example, of a rigid material such as a metal, ceramic or polymer material. Other materials are within the contemplated scope of disclosure. The battery module housing 102 may be formed, for example, by mold forming, milling, casting, etc.

As illustrated in FIG. 1C, the battery cell stacks 104 may be arranged in the battery module housing 102 such that the positive ends 104p and the negative ends 104n alternate between facing the first sidewall 102s1 of the battery module housing 102 and facing the second sidewall 102s2 of the battery module housing 102. The battery cell stacks 104 may be connected together in a series. In an alternative embodiment, the battery cell stacks 104 may be connected together in parallel. In at least one embodiment, the battery cell stacks 104 may include a combination of series connections and parallel connections. The battery module 100 may also include battery cell stack interconnects 110 (e.g., bus bars) for electrically coupling the ends of the battery cell stacks 104. The interconnects 110 may be press fit or otherwise fastened to the battery cell stack terminals.

The battery module 100 may also include a positive wiring line 112p connecting the positive end 104p of the series connected battery cell stacks 104 to the positive terminal 106P. The battery module 100 may also include negative wiring line 112n connecting the negative end 104n of the series connected battery cell stacks 104 to the negative terminal 106N. The positive wiring line 112p and the negative wiring line 112n may be formed, for example, of an insulated wire, such as an insulated copper wire. Other materials may be within the contemplated scope of disclosure.

The battery module 100 may also include a battery management system (BMS) 120 for controlling an operation of the battery module 100. The BMS 120 may be electrically coupled to each of the battery cell stacks 104. In at least on embodiment, the BMS 120 may include a cell interface that measures cell voltages and temperatures and provides cell balancing (e.g., equalization).

The BMS 120 may keep the battery module 100 from operating outside of its safety margins, and monitor the battery cell stacks 104 and calculate how much current can safely go in (charge) and come out (discharge) without damaging the battery module 100.

The BMS 120 may thereby prevent a source (e.g., a battery charger) and load (such as an inverter) from overdrawing or overcharging the battery. The BMS 120 may also monitor the remaining charge in the battery, continually tracking the amount of energy (e.g., power) entering and exiting the battery cells 103 and/or battery cell stacks 104 and monitoring voltages and/or currents of the battery cell stacks 104. The BMS 120 may collect and store data indicating that the battery module 100 is drained and shut the battery module 100 down. The BMS 120 may also monitor a temperature inside the battery module 100 and control a temperature control system (e.g., cooling fans) (not shown) of the battery module 100 to help maintain the temperature within an operating range. The BMS 120 may also detect a problem (e.g., a short) in the electrical circuitry of the battery module 100.

In at least one embodiment, the BMS 120 may monitor the state of charge (SOC) of the battery cells 103 and/or battery cell stacks 104 and thereby help to identify a bad battery cell 103 and/or a battery cell stack 104 in the battery module 100. The BMS 120 may also reconfigure the battery module 100 to allow for repurposing of the battery module 100 from one application to another application. The BMS 120 may also include a communications (e.g., telematics) unit that allows the battery module 100 to receive/store and transmit information (e.g., by wireless or wired connection) to and from an external device. In at least one embodiment, the BMS 120 may include a wireless transceiver for wirelessly communicating with a remote device over a wireless network (e.g., cellular, WiFi, bluetooth, etc.). In at least one embodiment, the BMS 120 may include an external communication capability allowing the BMS 120 to communicate with an external device outside of the battery module 100.

The battery module 100 may also include an input/output (I/O) port 140 located on the battery module housing 102. In at least one embodiment, the I/O port 140 may be located on the third sidewall 102s3 of the battery module housing 102. The I/O port 140 may include any type of data transfer port, such as an RJ45 port. The I/O port 140 may be electrically coupled to the BMS 120, and data may be transmitted to and from the BMS 120 through the I/O port 140.

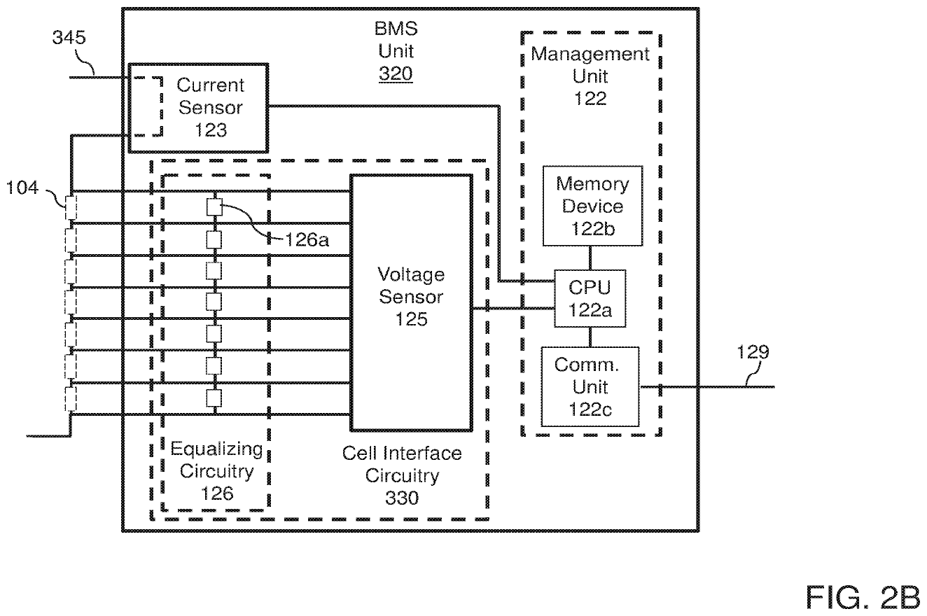

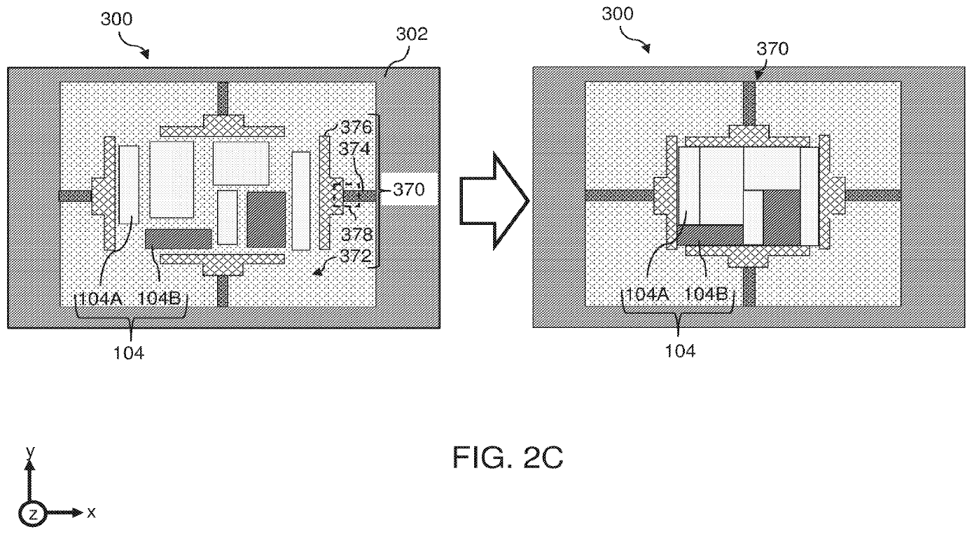

FIGS. 2A-2C illustrate a battery pack 300 having a first design according to a first embodiment. In particular, FIG. 2A is a plan view of the battery pack 300 having the first design. As illustrated in FIG. 2A, the battery pack 300 having the first design may include a plurality of battery cell stacks 104 that may include one or more battery calls 103 (shown in FIG. 1A). The battery cells stacks 104 are illustrated in FIG. 2A as being arranged longitudinally in the y-direction, but the battery cell stacks 104 may alternatively or additionally be arranged longitudinally in the x-direction and/or the z-direction (e.g., vertically). The battery cell stacks 104 are also illustrated in FIG. 2A as being connected in series by interconnects 310 (e.g., bus bars) for electrically coupling the ends of the battery cell stacks 104, but the battery cell stacks 104 may also be connected in parallel or include a combination of both series and parallel connections. The interconnects 310 may be press fit or otherwise fastened to the negative terminals and positive terminals of the battery cell stacks 104.

The battery pack 300 may include a battery pack housing 302 that houses the battery cell stacks 104. The battery pack housing 302 may have a construction similar to the construction of the battery module 100 described above. In particular, the battery pack housing 302 may have a substantially cuboid shape including a box-shaped case body (lower section) with a lid (upper or side section) that opens upward or sideways. The view of FIG. 2A is a view down into the lower section with the upper or side section (e.g., lid) omitted for ease of understanding. The battery pack housing 302 may include sidewalls formed, for example, of a rigid material such as a metal, ceramic or polymer material.

The battery pack 300 may further include battery pack terminals 306 (e.g., external terminals) connected to the battery cell stacks 104. The battery pack terminals 306 may include a positive battery pack terminal 306P connected (e.g., electrically connected) to a positive end of the plurality of battery cells stacks 104, and a negative battery pack terminal 306N connected (e.g., electrically connected) to a negative end of the plurality of battery cells stacks 104. The positive battery pack terminal 306P and the negative battery pack terminal 306N may be mounted on a wall (e.g., lid or side facing wall) of the battery pack housing 302. The battery pack terminals 306 may be similar in construction to the terminals 106 of the battery module 100 described above. In at least one embodiment, the battery pack terminals 306 may be configured to be connected to an electrical system of a structure (e.g., commercial building, residence, etc.) or device (e.g., machine, tool, vehicle, aircraft, watercraft, etc.) in order to power the structure or device.

The battery pack 300 may further include a battery management system (BMS) unit 320 configured to monitor and control an operation of the battery pack 300 including an operation of the battery cells stacks 104. The BMS unit 320 may mounted on or in the battery pack housing 302. The BMS unit 320 may be connected to each of the battery cell stacks 104 by one or more battery pack wiring lines 345. In at least one embodiment, the BMS unit 320 may be connected to the positive end and negative end of each of the battery cell stacks 104 by a battery pack wiring lines 345. The BMS unit 320 may also an external I/O port 320a connected to an I/O connector 329a of a communication line 329. The BMS unit 320 may transmit data signals to and receive data signals from an external device (e.g., outside the battery pack 300) via the communication line 329. In particular, where the battery pack 300 is included in an energy storage system, the battery pack 300 may communicate with a controller of the energy storage system via the communication line 329. Alternatively, the communication line 329 may be omitted if the BMS unit 320 is configured for wireless communication.

The BMS unit 320 may keep the battery pack 300 from operating outside of its safety margins. The BMS unit 320 may monitor each of the battery cell stacks 104 (and/or each of the battery cells 103 in each of the battery cell stacks 104) and calculate how much current can safely go in (charge) and come out (discharge) without damaging the battery pack 300. The BMS unit 320 may thereby prevent a source (e.g., a battery charger) and load (such as an inverter) from overdrawing or overcharging the battery pack 300. The BMS unit 320 may monitor the remaining charge in the battery pack 300, continually tracking the amount of energy (e.g., power) entering and exiting the battery cell stacks 104 and monitoring voltages of the battery cell stacks 104. The BMS unit 320 may collect and store data indicating that the battery pack 300 is drained and shut the battery pack 300 down. The BMS unit 320 may also detect a problem (e.g., a short) in the electrical circuitry of the battery pack 300.

The battery pack 300 may also include a temperature control system (TCS) unit 325 for controlling a temperature and other environmental conditions (e.g., humidity) inside the battery pack 300. The TCS unit 325 may operate under control of the BMS unit 320.

The TCS unit 325 may be mounted, for example, on an inner wall of the battery pack housing 302. The TCS unit 325 may include one or more devices for heating and cooling the battery pack 300 so as to maintain the battery cell stacks 104 within an operational temperature range. In particular, the TCS unit 325 may include one or more sensors (e.g., temperature sensors, humidity sensors, etc.), a heating unit (e.g., heating plates, resistance heaters, etc.) and/or cooling unit (e.g., cooling plates, fans, etc.).

The structure and configuration of the battery cell stacks 104 in the battery pack 300 may allow them to be conveniently removed and replaced. In at least one embodiment, the battery cell stacks 104 may have a “plug and play” structure and configuration in which the battery cell stacks 104 slide conveniently into and out of connection between the interconnects 310, battery pack wiring lines 345 and the battery pack terminals 306. This may allow the battery pack 300 to accommodate and facilitate the repurposing of battery cell stacks 104. In particular, the battery cell stacks 104 in the battery pack 300 may include one or more repurposed battery cell stacks 104 (e.g., battery cell stacks that were previously used for another purpose).

As illustrated in FIG. 2A, the battery cell stacks 104 may include a plurality of different types of battery cells stacks. In particular, the battery cell stacks 104 may include one or more first battery cell stacks 104A and one or more second battery cell stacks 104B. The first battery cell stacks 104A may have a first type and the second battery cell stacks 104B may have a second type that is different than the first type. The “type” of a battery cell stack 104 may refer to a functionality of the battery cells 103 in the battery cell stack 104, a chemical composition of the battery cells 103 in the battery cell stack 104, configuration of the battery cells 103 in the battery cell stack 104, previous use of the battery cells 103 in the battery cell stack 104, and so on. Thus, for example, the first battery cell stacks 104A may have a first chemical composition and the second battery cell stacks 104B may include a second chemical composition different than the first chemical composition. For example, the first battery cell stacks 104A may include lithium iron phosphate battery cells and the second battery cell stacks 104B may include lithium cobalt oxide battery cells. As another example, the first battery cell stacks 104A may include lithium ion battery cells and the second battery cell stacks 104B may include nickel cadmium battery cells.

The BMS unit 320 may monitor and track a performance of both the first type of battery cell stacks 104A and the second type of battery cell stacks 104B. The BMS unit 320 may include, for example, an architecture and wiring schematics that are standardized to accommodate the first type of battery cell stacks 104A and the second type of battery cell stacks 104B. Thus, the configuration of the BMS unit 320 may further allow the battery pack 300 to accommodate and facilitate the repurposing of battery cell stacks 104.

FIG. 2B is a schematic view of the BMS unit 320 in the battery pack 300 having the first design according to one or more embodiments. As illustrated in FIG. 2B, the BMS unit 320 may include a management unit 122, and at least one of a current sensor 123 and/or a voltage sensor 125. The BMS unit 320 may also include cell interface circuitry 330 including the voltage sensor 125 and equalizing circuitry 126. The BMS unit 320 is one example of a management system that may be used to manage an operation of the battery pack 300. Other management systems may be within the contemplated scope of disclosure.

The management unit 122 may operate with electric power supplied from the battery cells 103. The management unit 122 may include a central processing unit (CPU) 122a (e.g., microprocessor), a memory device 122b (e.g., read-only memory (ROM), random access memory (RAM), etc.), a communication unit 122c (e.g., telematics unit), and the like. The memory device 122b may include ROM for storing various control programs and data indicating post-discharge open-circuit voltage (OCV) and state-of-charge (SOC) characteristics. The CPU 122a may control each part of the battery pack 300 by executing a control program stored in the ROM. The communication unit 122c may communicate (e.g., by wire or wirelessly) with an external controller that is outside the battery pack 300. In at least one embodiment, the communication unit 122c may be connected by a communication line 129 to the external controller.

In at least one embodiment, the memory device 122b may store history data for each of the battery cell stacks 104 in the battery pack 300. The history data may include, for example, including capacity history data, voltage history data, charging history data, discharging history data, etc. The memory device 122b may also store identification data for each of the battery cell stacks 104 in the battery pack 300. The identification data may include, for example, the type of battery cells (e.g., lithium ion battery cells, nickel cadmium battery cells, etc.) in the battery cell stacks 104. The identification data may also include the date of inserting each of the battery cell stacks 104 in the battery pack 300, and whether the battery cell stack 104 is a repurposed battery cell stack 104 (e.g., a battery cell stack 104 previously used to for the same and/or different purpose for which it is being used in the battery pack 300). The identification data may also be generated by the CPU 122a which may execute software stored in the memory device 122b to generate such identification data for each of the battery cell stacks 104. In particular, the CPU 122a may generate the identification data by comparing the stored history data for the battery cell stacks 104 to one or more reference tables and look-up tables stored in the memory device 122b. The CPU 122a may then control an operation of the battery pack 300 (e.g., charging operation, discharging operation, etc.) based on the identification data for each of the battery cell stacks 104.

In at least one embodiment, the battery pack 300 may be included in an ESS (e.g., residential ESS). In that case, the communication unit 122c may transmit data signals to and receive data signals from an ESS controller for the ESS over the communication line 129 (or wirelessly). Data signals received by the management unit 122 from the ESS controller may include battery pack charging instructions, battery pack discharging instructions, and the like.

The current sensor 123 may be connected to the battery cell stacks 104 (or battery cells 103) by the battery pack wiring lines 345. The current sensor 123 may measure a current value of a charge current flowing to the battery cell stacks 104 during charge, and a current value of a discharge current flowing from the battery cell stacks 104 to an electric load during discharge. The current sensor 123 may then output the measured current value to the CPU 122a of the management unit 122.

The voltage sensor 125 of the cell interface circuitry 330 may be connected to both ends of each battery cell stacks 104 (or battery cells 103). The voltage sensor 125 may measure a voltage value which is a terminal voltage of the battery cell stacks 104 (or battery cells 103) and output the measured voltage value to the CPU 122a of the management unit 122.

The equalizing circuitry 126 of the cell interface circuitry 330 may include equalizing circuits 126a in parallel connection with each of the battery cell stacks 104 (or battery cells 103). Each equalizing circuit 126a may include, for example, a switch element and a discharge resistor. When the switch element is turned on, electric power of the battery cell or stack in parallel connection with the equalizing circuit 126a may be discharged by the discharge resistor.

When the battery cells 103 of the battery cell stacks 104 are brought into a pause state, the management unit 122 may measure the open circuit voltage (OCV) with the voltage sensor 125 and estimate the state of charge (SOC) of the battery cells 103 by specifying the SOC corresponding to the measured OCV from the post-discharge OCV-SOC characteristics stored in the memory device 122b. In at least one embodiment, the management unit 122 may estimate the SOC of the battery cells 103 (e.g., execute an SOC estimation process) by first causing the equalizing circuit 126 to discharge the battery cells 103 for a predetermined time. The management unit 122 may then measure the OCV with the voltage sensor 125.

The management unit 122 may then estimate the SOC of the battery cells 103 by specifying the SOC corresponding to the OCV measured from the post-discharge OCV-SOC characteristics.

FIG. 2C is a plan view of a battery pack bracket 370 in the battery pack 300 having the first design according to one or more embodiments. It should be noted that an upper section (e.g., lid) of the battery pack housing 302 and other features of the battery pack 300 (e.g., the BMS unit 320, the TCS unit 325, the battery pack wiring lines 345, interconnects 310 and battery pack terminals 306) have been omitted from FIG. 2C for ease of understanding. As illustrated in FIG. 2C, the battery pack bracket 370 may be located in the battery pack housing 302. The battery pack bracket 370 may be used to fix a position of the battery cell stacks 104 in the battery pack housing 302.

The battery pack bracket 370 may be mounted (e.g., by fasteners such as screws, bolts, etc.) to a wall of the battery pack housing 302. In at least one embodiment, the battery pack bracket 370 may be mounted to the bottom wall. The battery pack bracket 370 may include a mounting plate 372 mounted to a wall of the battery pack housing 302. The battery pack bracket 370 may also include one or more tracks 374 on the mounting plate 372. The tracks 374 may be integrally formed with the mounting plate 372 or may be connected to the mounting plate 372 by fasteners. The battery pack bracket 370 may also include bracket walls 376 that are slidably mounted on the tracks 372.

The battery pack bracket 370 may also include locking mechanisms 378 that may lock the respective bracket wall 376 in position on the respective of a plurality of tracks (or portion of a unitary track) 374. The locking mechanism 378 may include, for example, one or more spring-loaded pins on the bracket wall 376 and a plurality of positioning holes located along the length of the one or more tracks 374.

In operation, the battery cell stacks 104 may be placed on a central region of the mounting plate 372 as shown on the left side of FIG. 2C. The battery cell stacks 104 may include the first battery cell stacks 104A and second battery cells stacks 104B. The first battery cell stacks 104A and second battery cells stacks 104B may have a plurality of shapes, plurality of sizes and plurality of orientations. The spring-loaded pins may be depressed by a user to retract the pins out of the positioning holes and allow the bracket wall 376 to move slidably along the track 374. The bracket wall 376 may be pushed by the user toward the central region of the mounting place 372, contact one or more of the battery cell stacks 104 and thereby force the contacted battery cell stacks 104 toward the central region of the mounting plate 372.

After the bracket walls 376 are moved into a desirable position as shown on the right side of FIG. 2C) the spring-loaded pins may be released, so as to be forced into one or more of the positioning holes in the track 374 and fix the bracket walls 376 into position. In at least one embodiment, the spring-loaded pins may be depressed and the bracket walls 376 moved by one more electric motors, pulleys, gears, etc. under the control of the BMS unit 320 (see FIG. 2B). By pushing in the bracket walls 376 (e.g., four bracket walls 376) along all four sides of the mounting plate 372, any spaces between the battery cell stacks 104 may be minimized (e.g., eliminated) and the battery cell stacks 104 may be securely held in a fixed position by the bracket walls 376. It should be noted that thermal control plates (e.g., cooling plates) may be inserted between the battery cell stacks 104, but are omitted in FIG. 2C for ease of understanding. The battery pack bracket 370 may accommodate a plurality of types, plurality of shapes, plurality of sizes and/or plurality of orientations of the battery cell stacks 104. The battery pack bracket 370 may also accommodate multiple configurations of the battery cell stacks 104 while the BMS unit 320 maintains safe operation of the battery pack 300.

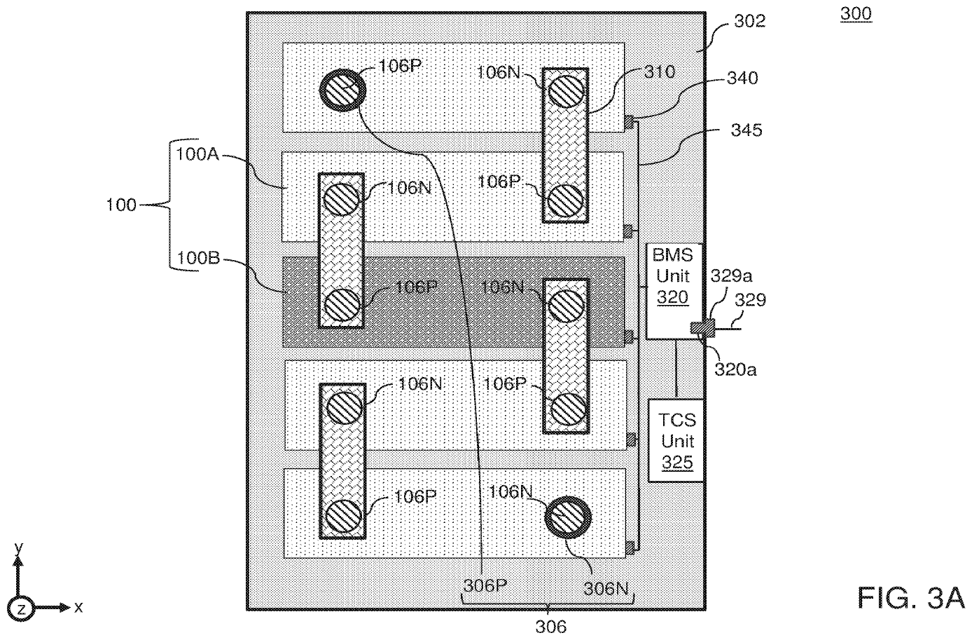

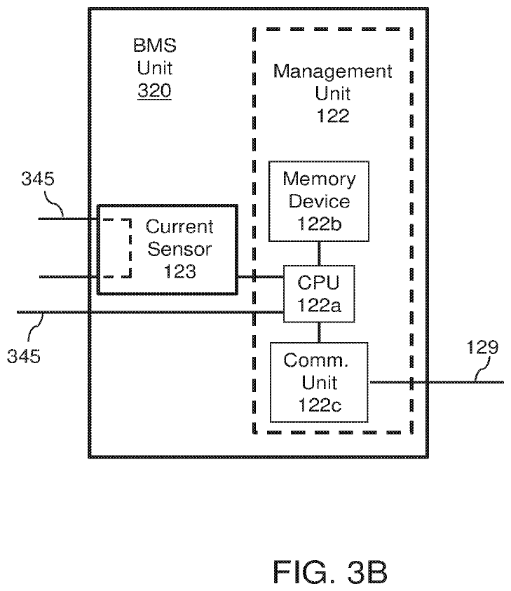

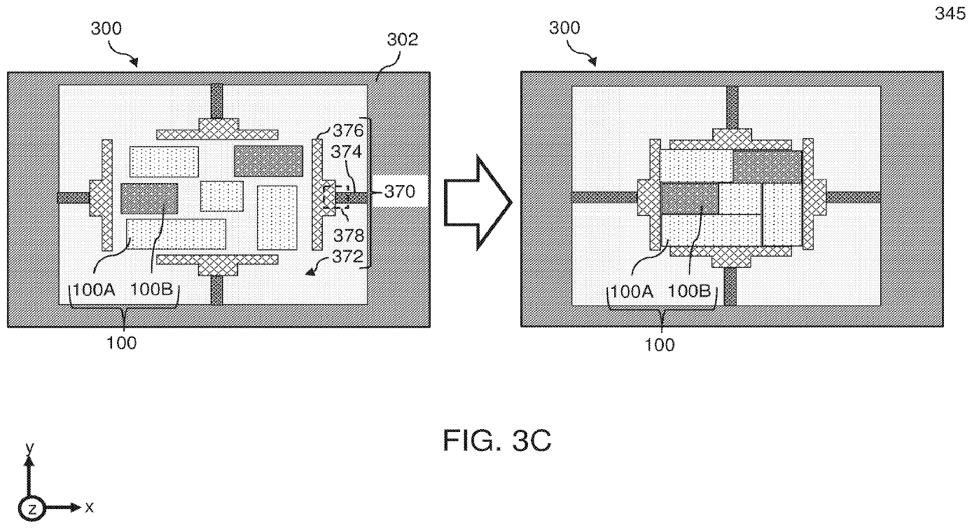

FIGS. 3A-3C illustrate the battery pack 300 having a second design according a second embodiments. In particular, FIG. 3A is a plan view of the battery pack 300 having the second design. As illustrated in FIG. 3A, the battery pack 300 having the second design may include a plurality of battery modules 100. The battery modules 100 are illustrated in FIG. 3A as being arranged longitudinally in the x-direction, but the battery modules 100 may also be arranged longitudinally in the y-direction and/or the z-direction (e.g., vertically) in addition to or instead of the x-direction. The battery modules 100 are also illustrated in FIG. 3A as being connected in series by the interconnects 310 for electrically coupling the positive terminals 106P and negative terminals 106N of the battery modules 100, but the battery modules 100 may alternatively be connected in parallel or include a combination of both series and parallel connections. The interconnects 310 may be press fit or otherwise fastened to the positive terminals 106P and negative terminals 106N of the battery modules 100. The positive battery pack terminal 306P may be connected to a positive terminal 106P at one end of the plurality of battery modules 100, and a negative battery pack terminal 306N connected to a negative terminal 106N at an opposite end of the plurality of battery modules 100.

The BMS unit 320 in the second design of the battery pack 300 may be configured to monitor and control an operation of the battery pack 300 including an operation of each of the battery modules 100. The BMS unit 320 may include a plurality of input/output (I/O) connectors 340 (e.g., RJ45 connectors) connected to the I/O ports 140 of the battery modules 100. The BMS unit 320 may be communicatively coupled to the I/O connectors 340 via the battery pack wiring lines 345. The BMS unit 320 may work cooperatively with the BMS 120 of each of the battery modules 100. In at least one embodiment, the BMS 120 may transmit cell voltage data, cell temperature data and cell balancing data to the BMS unit 320 of the battery pack 300. In at least one embodiment, the BMS unit 320 and BMS 120 may have a “master and slave” configuration in which BMS unit 320 of the battery pack 300 controls an operation of the BMS 120 in each of the battery modules 100. The BMS unit 320 may monitor the battery modules 100 (e.g., each of the battery cells 103 or stacks 104 in each of the battery modules 100) and calculate how much current can safely go in (charge) and come out (discharge) without damaging the battery pack 300. The BMS unit 320 may also monitor voltages of the battery modules 100.

The structure and configuration of the battery modules 100 in the battery pack 300 may allow them to be conveniently removed and replaced. In at least one embodiment, the battery modules 100 may have a “plug and play” structure and configuration in which the battery modules 100 slide conveniently into and out of connection between the interconnects 310, battery pack wiring lines 345 and the battery pack terminals 306. For example, referring to FIG. 3A, the interconnects 310 and the battery pack terminals 306 may be mounted on a lid (not shown) of the battery pack 300. In that case, a battery module 100 may be removed from the battery pack 300 may simply lifting the lid to separate the interconnects 310 and the battery pack terminals 306 from the battery modules 100. This may allow the battery pack 300 to accommodate and facilitate the repurposing of battery modules 100. In particular, the battery modules 100 in the battery pack 300 may include one or more repurposed battery modules 100 (e.g., battery modules that were previously used for another purpose).

As illustrated in FIG. 3A, the battery modules 100 may include a plurality of different types of battery modules. In particular, the battery modules 100 may include one or more first battery modules 100A and one or more second battery modules 100B. The first battery modules 100A may have a first type and the second battery modules 100B may have a second type that is different than the first type. The “type” of a battery module 100 may refer to a functionality of the battery cells 103 in the battery module 100, a chemical composition of the battery cells 103 in the battery module 100, configuration of the battery cells 103 in the battery cell stacks 104 of the battery module 100, and so on. Thus, for example, the first battery modules 100A may have a first chemical composition and the second battery modules 100B may include a second chemical composition different than the first chemical composition. For example, the first battery modules 100A may include lithium iron phosphate battery cells and the second battery modules 100B may include lithium cobalt oxide battery cells. As another example, the first battery modules 100A may include lithium ion battery cells and the second battery modules 100B may include nickel cadmium battery cells.

The BMS unit 320 may monitor and track a performance of both the first type of battery modules 100A and the second type of battery modules 100B. The BMS unit 320 may include, for example, an architecture and wiring schematics that are standardized to accommodate the first type of battery modules 100A and the second type of battery modules 100B. Thus, the configuration of the BMS unit 320 may further allow the battery pack 300 to accommodate and facilitate the repurposing of battery modules 100.

FIG. 3B is a schematic view of the BMS unit 320 in the battery pack 300 having the second design according to one or more embodiments. The BMS unit 320 for the battery pack 300 having the second design may have a functionality similar to the BMS unit 320 for the battery pack 300 having the first design. However, since the BMS 120 of the battery modules 100 may include cell interface circuitry and functionality, the cell interface circuitry 330 (see FIG. 2B) may not be included in the BMS unit 320 for the battery pack 300 having the second design.

As illustrated in FIG. 3B, the BMS unit 320 may include the management unit 122 and the current sensor 123. The CPU 122a of the management unit 122 may receive voltage data from the BMS 120 of the battery modules 100 via the battery pack wiring lines 345. The current sensor 123 may also be connected to the battery modules 100 by the battery pack wiring lines 345. The current sensor 123 may measure a current value of a charge current flowing to the battery modules 100 during charge, and a current value of a discharge current flowing from the battery modules 100 to an electric load during discharge. The current sensor 123 may then output the measured current value to the CPU 122a of the management unit 122.

In at least one embodiment, the memory device 122b may store history data for each of the battery modules 100 in the battery pack 300. The history data may include, for example, including capacity history data, voltage history data, charging history data, discharging history data, etc. The memory device 122b may also store identification data for each of the battery cell stacks 104 in the battery pack 300. The identification data may include, for example, the type of battery cells (e.g., lithium ion battery cells, nickel cadmium battery cells, etc.) in the battery modules 100. The identification data may also include the date of inserting each of the battery modules 100 in the battery pack 300, and whether the battery module 100 is a repurposed battery module 100 (e.g., a battery module 100 previously used to for the purpose for which it is being used in the battery pack 300). The identification data may be obtained (at least in part) from the BMS 120 in each of the battery modules 100 which may store the identification data for the battery modules 100. The identification data may also be generated by the CPU 122a which may execute software stored in the memory device 122b to generate such identification data for each of the battery modules 100. In particular, the CPU 122a may generate the identification data by comparing the stored history data for the battery module 100 to one or more reference tables and look-up tables stored in the memory device 122b. The CPU 122a may then control an operation of the battery pack 300 (e.g., charging operation, discharging operation, etc.) based on the identification data for each of the battery modules 100.

FIG. 3C is a plan view of a battery pack bracket 370 in the battery pack 300 having the second design according to one or more embodiments. The battery pack bracket 370 in the battery pack 300 having the second design may be substantially the same as the battery pack bracket 370 in the battery pack 300 having the first design (see FIG. 2C). The battery pack bracket 370 may be used to fix a position of the battery modules 100 in the battery pack housing 302.

In operation, the battery modules 100 may be placed on a central region of the mounting plate 372 as shown on the left side of FIG. 3C. The battery modules 100 may include the first battery modules 100A and second battery modules 100B. The first battery modules 100A and second battery modules 100B may have a plurality of shapes, plurality of sizes and plurality of orientations. The spring-loaded pins may be depressed by a user to retract the pins out of the positioning holes and allow the bracket walls 376 to move slidably along the track(s) 374. The bracket walls 376 may be pushed by the user toward the central region of the mounting place 372, contact one or more of the battery modules 100 and thereby force the contacted battery modules 100 toward the central region of the mounting plate 372.

After the bracket walls 376 are moved into a desirable position as shown on the right side of FIG. 3C, the spring-loaded pins may be released, so as to be forced into one or more of the positioning holes in the track(s) 374 and fix the bracket walls 376 into position. In at least one embodiment, the spring-loaded pins may be depressed and the bracket walls 376 moved by one more electric motors, pulleys, gears, etc. under the control of the BMS unit 320 (see FIG. 3B). By pushing in the bracket walls 376 (e.g., four bracket walls 376) along all four sides of the mounting plate 372, any spaces between the battery modules 100 may be minimized (e.g., eliminated) and the battery modules 100 may be securely held in a fixed position by the bracket walls 376. It should be noted that thermal control plates (e.g., cooling plates) may be inserted between the battery modules 100, but are omitted in FIG. 3C for ease of understanding. The battery pack bracket 370 may accommodate a plurality of types, plurality of shapes, plurality of sizes and plurality of orientations of the battery modules 100. The battery pack bracket 370 may also accommodate multiple configurations of the battery cell stacks 104 while the BMS unit 320 maintains safe operation of the battery pack 300.

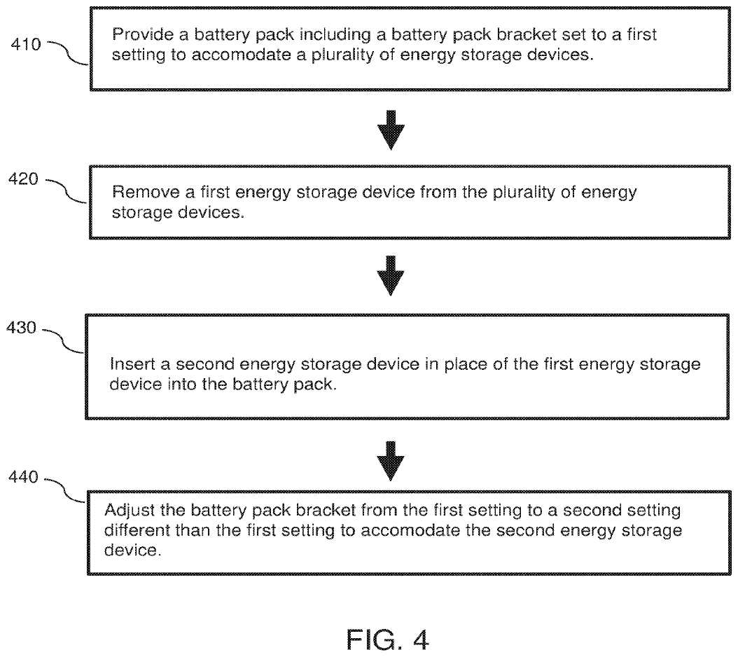

FIG. 4 is a flow chart illustrating a method of replacing an energy storage device (e.g., battery cell stack 104 and/or battery module 100) in the battery pack 300 according to one or more embodiments. Step 410 may include providing a battery pack including a battery pack bracket set to a first setting to accommodate a plurality of energy storage devices. Step 420 may include removing a first energy storage device from the plurality of energy storage devices. Step 430 may include inserting a second energy storage device in place of the first energy storage device into the battery pack. Step 440 may include adjusting the battery pack bracket from the first setting to a second setting different than the first setting to accommodate the second energy storage device. The first energy storage device may have a first size, a first shape and a first orientation, and the second energy storage device may have at least one of a second size different than the first size, a second shape different than the first shape, or a second orientation different than the first orientation. The method may also include locking the battery pack bracket into the second setting using a locking mechanism of the battery pack bracket.

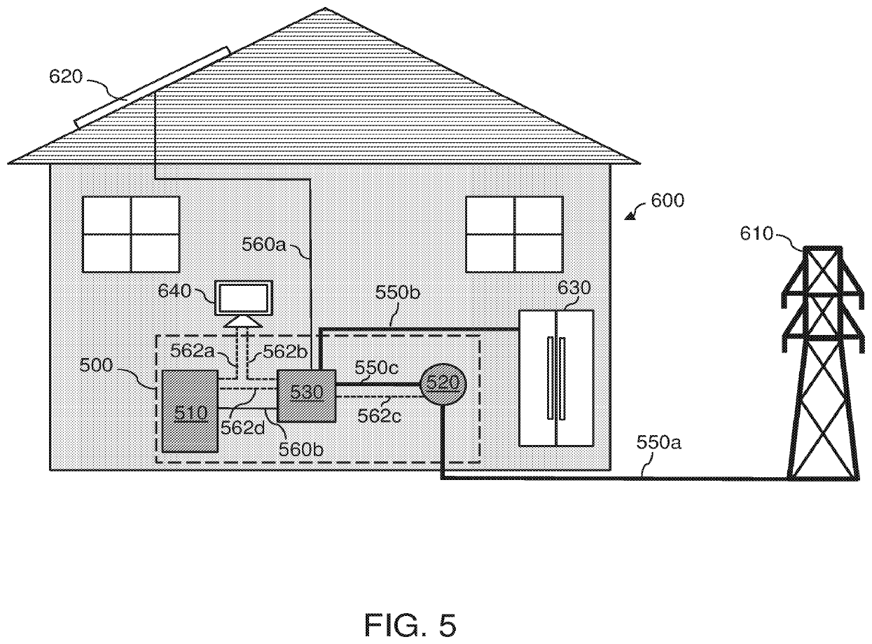

FIG. 5 is a schematic illustration of an energy storage system (ESS) 500 according to one or more embodiments. As illustrated in FIG. 5, the ESS 500 may include an ESS unit 510 that includes one or more of the battery packs 300. The ESS 500 may also include an electric meter 520 that measures electric power in the ESS 500 and an inverter 530 that may convert DC power to AC power and convert AC power to DC power.

The ESS 500 may be used to store energy for use in a structure 600 such as a residential building, commercial building, etc. The ESS 500 may be electrically coupled to an electric power generating source 610 (e.g., electric power grid powered by an electric utility power plant) via an AC power line 550a. The ESS 500 may also be electrically coupled to one or more renewable energy power sources 620 (e.g., solar panels, wind turbines, etc.) via a DC power line 560a. The ESS 500 may also be electrically coupled to various electrical devices 630 (e.g., lights, appliances, etc.) in and around the structure 600 via an AC power line 550b. The ESS 500 may also be communicatively coupled to a network device 640 (e.g., router, computer, etc.) at the structure 600 via data lines 562a and 562b. The network device 640 may be connected to an external network, such as the Internet and may access the Cloud via the connection. A user may monitor a performance of the ESS 500 and/or control an operation of the ESS 500 by way of the network device 640.

Within the ESS 500, electric power (e.g., AC power) may be transmitted between the electric meter 520 and the inverter 530 via an AC power line 550c. The electric meter 520 may also be communicatively coupled to the inverter 530 via data line 562c. Further, electric power (e.g., DC power) may be transmitted between the ESS unit 510 and the inverter 530 via the DC power line 560b. The ESS unit 510 and the inverter 530 may also be communicatively coupled via data line 562d. It should be noted that each of the ESS unit 510, electric meter 520 and inverter 530 may also be equipped with a wireless transceiver, so that each of the data lines 562a, 562b, 562c may be replaced with a wireless connection from the wireless transceivers.

In operation, electric power generated by the electric power generating source 610 may be used to power the electric devices 630. In this case, electric power may be transmitted to the electric meter 520 via the AC power line 550a, from the electric meter 520 to the inverter 530 via AC power line 550c, and from the inverter 530 to the electrical devices 630 via the AC power line 550b. Electric power generated by the renewable energy source 620 may also be used to power the electric devices 630. In this case, electric power may be transmitted as DC current to the inverter 530 via the DC power line 560a. The inverter 530 may convert the DC current to AC current, and then transmit the AC current to the electrical devices 630 via the AC power line 550b. Electric power stored by the battery pack 300 in the ESS unit 510 may also be used to power the electric devices 630. In this case, the energy storage devices (e.g., battery cell stacks 104, battery modules 100) in the battery pack 300 (see FIGS. 2A and 3A) may be discharged to provide electric power that may be transmitted as DC current to the inverter 530 via the DC power line 560b. The inverter 530 may then convert the DC current to AC current, and then transmit the AC current to the electrical devices 630 via the AC power line 550b.

Electric power generated by the electric power generating source 610 may also be used to charge the energy storage devices in the battery pack 300 of the ESS unit 510. In this case, electric power from the electric power generating source 610 may be converted to DC current in the inverter 530 and transmitted to the battery pack 300 in the ESS unit 510 via the DC power line 560b. Electric power generated by the renewable energy source 620 may also be used to charge the energy storage devices in the battery pack 300 of the ESS unit 510. In this case, electric power from the renewable energy source 620 may be transmitted from the inverter 530 to the battery pack 300 in the ESS unit 510 via the DC power line 560b.

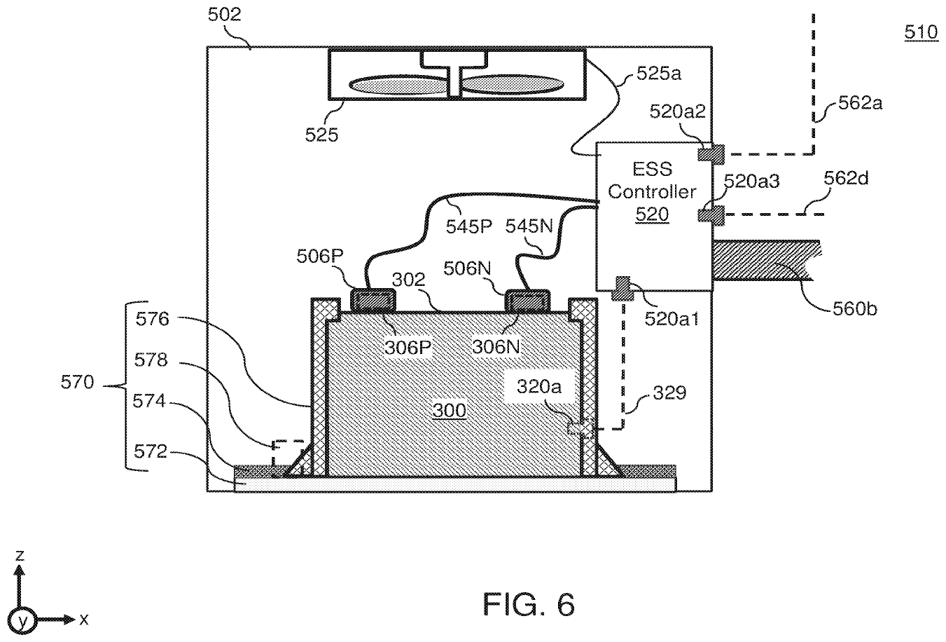

FIG. 6 is a vertical cross-sectional view of the ESS unit 510 according to one or more embodiments. As illustrated in FIG. 6, the ESS unit 510 may include an ESS unit housing 502 and one or more battery packs 300 housed in the ESS unit housing 502. The ESS unit 510 may also include an ESS controller 520 for controlling an operation of the ESS unit 510 and in particular an operation of the battery pack 300. The ESS unit 510 may also include a TCS 525 (e.g., fan or cooling coil) that may regulate a temperature and other environmental conditions in the ESS unit housing 502 under control of the ESS controller 520. The ESS unit 510 may also include an ESS unit bracket 570 that may secure the battery pack 300 and fix a position of the battery pack 300 in the ESS unit housing 502.

The ESS unit housing 302 may be mounted, for example, inside or outside of the structure, such as for example on an interior or exterior wall of the structure 600. The ESS unit housing 502 may have a construction similar to the construction of the battery pack housing 302 described above. In particular, the ESS unit housing 502 may have a substantially cuboid shape including a box-shaped case body (back section) with a door (front section). A door or access panel may be connected to the box-shaped case body, for example, by one or more hinges. The view of FIG. 6 is a view from the front into the back section with the door or access panel omitted for ease of understanding. The ESS unit housing 502 may include walls formed, for example, of a rigid material such as a metal, ceramic or polymer material.

The ESS unit 510 may further include ESS unit terminals 506 connected to the battery pack 300. The ESS unit terminals 506 may include a positive ESS unit terminal 506P connected (e.g., electrically connected) to the positive battery pack terminal 306P, and a negative ESS unit terminal 506N connected (e.g., electrically connected) to the negative battery pack terminal 306N. The positive ESS unit terminal 506P may be connected to the ESS controller 520 by positive ESS unit wiring line 545P. The negative ESS unit terminal 506N may be connected to the ESS controller 520 by negative ESS unit wiring line 545N. The positive ESS unit terminal 506P and the negative ESS unit terminal 506N may be similar in construction to the battery pack terminals 306 of the battery pack 300.

The ESS unit bracket 570 may be similar in construction to the battery pack bracket 370 in the battery pack 300. The ESS unit bracket 570 may be used to fix a position of the battery pack 300 in the ESS unit housing 502. The ESS unit bracket 570 may be mounted (e.g., by fasteners such as screws, bolts, etc.) to a wall of the ESS unit housing 502. In at least one embodiment, the ESS unit bracket 570 may be mounted to the bottom wall of the ESS unit housing 502. The ESS unit bracket 570 may include a mounting plate 572 mounted to the sidewall of the ESS unit housing 502. The ESS unit bracket 570 may also include one or more tracks 574 on the mounting plate 572. One of the tracks 574 may be located on each of the four sides (in the x-y plane) of the mounting plate 572. The tracks 574 may be integrally formed with the mounting plate 572 or may be connected to the mounting plate 572 by fasteners. The ESS unit bracket 570 may also include bracket walls 576 that are slidably mounted on the tracks 572.

The ESS unit bracket 570 may also include a locking mechanism 578 that may lock the bracket wall 576 in position on the track(s) 574. The locking mechanism 578 may include, for example, one or more spring-loaded pins on the bracket wall 576 and a plurality of positioning holes located along the length of the track(s) 574. An operation of the ESS unit bracket 570 may be similar to the operation of the battery pack bracket 370 described above.

In a case where the ESS unit 510 includes more than one battery packs 300, the ESS unit bracket 570 may be used to fix a position of all of the battery packs 300. In that case, thermal control plates (e.g., cooling plates) may be inserted between the battery packs 300, but are omitted in FIG. 2C for ease of understanding. The ESS unit bracket 570 may accommodate a plurality of types, plurality of shapes, plurality of sizes and plurality of orientations of the battery packs 300. The ESS unit bracket 570 may also accommodate multiple configurations of the battery packs 300 while the ESS controller 520 (e.g., in cooperation with the BMS unit 320 in the battery pack 300) maintains safe operation of the ESS unit 510.

The TCS unit 525 may operate under control of the ESS controller 520 via the TCS data line 525a. The TCS unit 525 may be mounted, for example, on an inner sidewall of the ESS unit housing 502. The TCS unit 525 may include one or more devices for heating and cooling the ESS unit 510 so as to maintain the ESS unit 510 within an operational temperature range. In particular, the TCS unit 525 may include one or more sensors (e.g., temperature sensors, humidity sensors, etc.), a heating unit (e.g., heating plates, resistance heaters, etc.) and/or cooling unit (e.g., cooling plates, fans, etc.).

The ESS controller 520 may include an I/O port 520al communicatively coupled to the external I/O port 320a of the BMS unit 320 of the battery pack 300 via the optional communication line 329. The ESS controller 520 may transmit data signals to and receive data signals from the BMS unit 320 of the battery pack 300 via the communication line 329. In at least one embodiment, the ESS controller 520 and the BMS unit 320 of the battery pack 300 may have a master-slave configuration in which the ESS controller 520 (master) may control an operation of the BMS unit 320 (slave). The ESS controller 520 may also include I/O port 520a2 communicatively coupled to the data line 562a. A user may use the network device 640 to send data to the controller 520 and receive data from the controller 520 via the communication line 329. The ESS controller 520 may also include an I/O port 520a3 communicatively coupled to the data line 562d. The ESS controller 520 may transmit charge and discharge status information to the inverter 530 via the data line 562d. The ESS controller 520 may also transmit information regarding a status (e.g., capacity) of the battery pack 300 to the inverter 530 via the data line 562d. Alternatively, the lines 329, 562a and/or 562d may be replaced by wireless data connections.

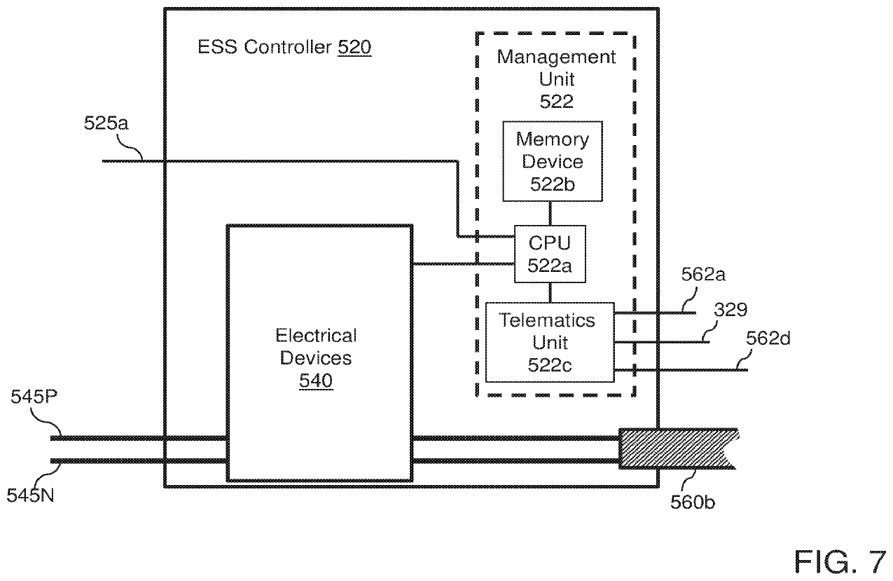

FIG. 7 is a schematic illustration of the ESS controller 520 according to one or more embodiments. The ESS controller 520 may be serve as an interface between the ESS unit 510 and the other elements of the ESS 500 (e.g., electric meter 520 and inverter 530). In particular, the ESS controller 520 may be serve as an interface between the BMS unit 320 of the battery pack 300 and the other elements of the ESS 500. As illustrated in FIG. 7, the ESS controller 520 may include a management unit 522. The management unit 522 may include a central processing unit (CPU) 522a (e.g., microprocessor), a memory device 522b (e.g., read-only memory (ROM), random access memory (RAM), etc.), a telematics unit 522c (e.g., communication unit), and the like. The CPU 522a may be connected to the TCS unit 525 via the data line 525a or via a wireless data connection, and thereby control an operation of the TCS unit 525.

The ESS controller 520 may also include electrical devices 540 that are connected to the positive ESS unit wiring line 545P and negative ESS unit terminal 506N that are connected to the battery pack 300. The electrical devices 540 may serve as an interface between the DC power line 560b on one side, and the positive ESS unit wiring line 545P and negative ESS unit terminal 506N on the other side. The electrical devices 540 may be controlled by the CPU 522a. The electrical devices 540 may include, for example, devices such as electrical relays, electrical fuses and/or DC/DC converters that may be controlled by the CPU 522a. In particular, the CPU 522a may control charging and discharging operations of the battery pack 300 by controlling the electrical devices 540. The electrical devices 540 may thereby ensure a safe operation of the ESS unit 510 (e.g., preventing overcharging and over discharging of the battery pack 300).

The memory device 522b may include ROM for storing various control programs for controlling a charging operation and a discharging operation of the battery pack 300 in cooperation with the BMS unit 320. The memory device 522b may also include RAM for storing battery pack charging and discharging data (e.g., history data, performance data, etc.).

In at least one embodiment, the memory device 522b may store history data for each of the battery cell stacks 104 and/or battery modules 100 (e.g., energy storage devices) in the battery pack 300. The history data may include, for example, including capacity history data, voltage history data, charging history data, discharging history data, etc. The memory device 522b may also store identification data for each of the battery cell stacks 104 and/or battery modules 100 in the battery pack 300. The identification data may include, for example, the type of battery cells (e.g., lithium ion battery cells, nickel cadmium battery cells, etc.) in the battery cell stacks 104 and/or battery modules 100. The identification data may also include the date of inserting each of the battery cell stacks 104 and/or battery modules 100 in the battery pack 300, and whether the battery cell stack 104 and/or battery module 100 is a repurposed battery cell stack 104 and/or repurposed battery module 100 (e.g., a battery cell stack 104 and/or battery module 100 previously used to for the same or different purpose for which it is being used in the battery pack 300). The identification data may be obtained from the BMS unit 320 in the battery pack 300 which may store the identification data. The identification data may also be generated by the CPU 122a which may execute software stored in the memory device 522b to generate such identification data for each of the battery cell stacks 104 and/or battery modules 100. In particular, the CPU 122a may generate the identification data by comparing the stored history data for the battery cell stacks 104 and/or battery modules 100 to one or more reference tables and look-up tables stored in the memory device 522b. The CPU 122a may then control an operation of the battery pack 300 (e.g., charging operation, discharging operation, etc.) based on the identification data for each of the battery cell stacks 104 and/or battery modules 100.

The telematics unit 522c may be communicatively coupled to the network device 640 by the data line 562a and communicatively coupled to the BMS unit 320 via the communication line 329. The telematics unit 522c may transmit data signals to the BMS unit 320 (e.g., battery pack charging instructions, battery pack discharging instructions, etc.) and receive data signals from the BMS unit 320 via the communication line 329. The telematics unit 522c may also be communicatively coupled to the inverter 530 by the data line 562d. The telematics unit 522c may coordinate charging and discharging operations for the battery pack 300 via the data line 562d. Alternatively, the lines 329, 562a and/or 562b may be replaced with wireless data connections.

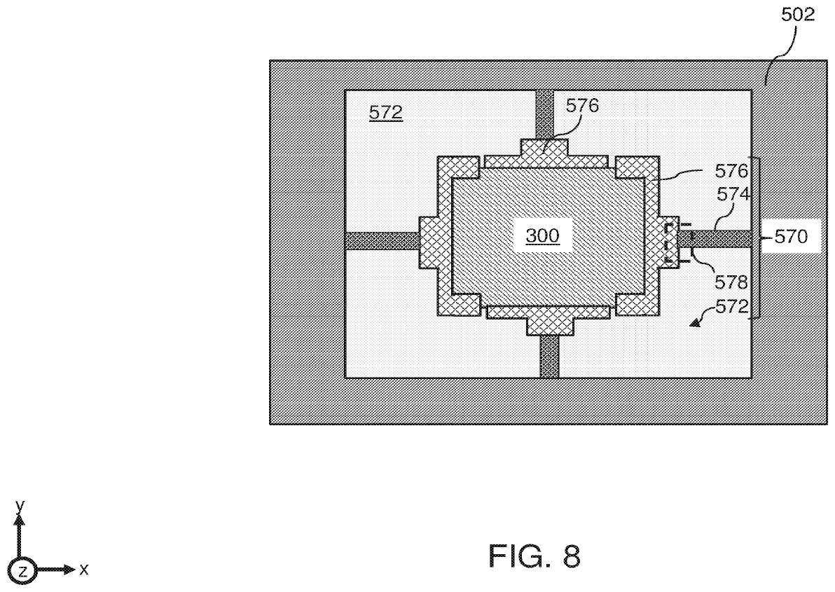

FIG. 8 is a plan view of the ESS unit bracket 570 in the ESS unit 510 according to one or more embodiments. As illustrated in FIG. 8, the bracket walls 576 may have different configurations. In particular, in one configuration, the bracket wall 576 may wrap around a corner of the battery pack 300 on opposing sides of the bracket wall 576. In another configuration, the bracket wall 576 may have a substantially planar configuration and may have a length (e.g., in the x-direction) less than a length of the battery pack 300 in the x-direction.

In operation, the battery pack 300 (or two or more battery packs 300) may be placed on a central region of the mounting plate 572. The battery packs 300 may have a plurality of shapes, plurality of sizes and plurality of orientations. The spring-loaded pins in the locking mechanism 578 may be depressed by a user to retract the pins out of the positioning holes of the locking mechanism 578 and allow the bracket wall 576 to move slidably along the track(s) 574. The bracket wall 576 may be pushed by the user toward the central region of the mounting place 572, contact one or more of the battery packs 300 and thereby force the contacted battery pack 300 toward the central region of the mounting plate 572.

After the bracket walls 576 are moved into a desirable position, the spring-loaded pins may be released, so as to be forced into one or more of the positioning holes in the track(s) 574 and fix the bracket walls 576 into position. In at least one embodiment, the spring-loaded pins may be depressed and the bracket walls 576 moved by one more electric motors, pulleys, gears, etc. under the control of the ESS controller 520 (see FIG. 7). By pushing in the bracket walls 576 (e.g., four bracket walls 576) along all four sides of the mounting plate 572, any spaces between the battery packs 300 may be minimized (e.g., eliminated) and the battery packs 300 may be securely held in a fixed position by the bracket walls 576. It should be noted that thermal control plates (e.g., cooling plates) may also be inserted between the battery packs 300. The ESS unit bracket 570 may accommodate a plurality of types, plurality of shapes, plurality of sizes and plurality of orientations of the battery packs 300. The ESS unit bracket 570 may also accommodate multiple configurations of the battery packs 300 while the ESS controller 520 maintains safe operation of the ESS unit 510.

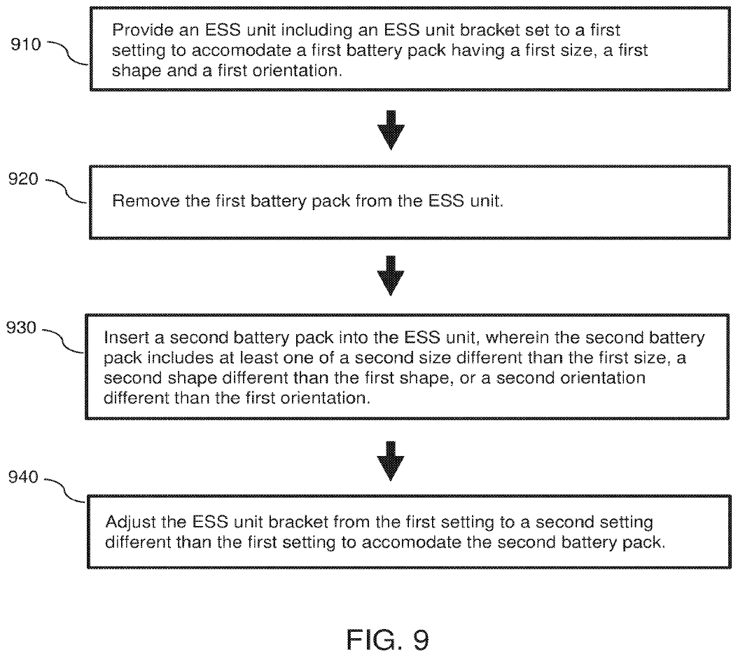

FIG. 9 is a flow chart illustrating a method of replacing the battery pack 300 in the ESS unit 510, according to one or more embodiments. Step 910 may include providing an ESS unit including an ESS unit bracket set to a first setting to accommodate a first battery pack having a first size, a first shape and a first orientation. Step 920 may include removing the first battery pack from the ESS unit. Step 930 may include inserting a second battery pack into the ESS unit, wherein the second battery pack includes at least one of a second size different than the first size, a second shape different than the first shape, or a second orientation different than the first orientation. Step 940 may include adjusting the ESS unit bracket from the first setting to a second setting different than the first setting to accommodate the second battery pack. The method may also include locking the ESS unit bracket into the second setting using a locking mechanism of the ESS unit bracket.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A battery pack, comprising:
a battery pack housing;
a plurality of energy storage devices of a plurality of different types located in the battery pack housing; and
a battery management system (BMS) unit electrically coupled to the plurality of energy storage devices and configured to manage an operation of the plurality of energy storage devices.

2. The battery pack of claim 1, wherein the plurality of different types of energy storage devices comprises a first type of energy storage device having a first chemical composition and a second type of energy storage device having a second chemical composition different than the first chemical composition.

3. The battery pack of claim 2, wherein:
the BMS unit monitors and tracks a performance of the first type of energy storage device and the second type of energy storage device; and
the BMS unit comprises an architecture and wiring schematics that are standardized to accommodate the first type of energy storage device and the second type of energy storage device.

4. The battery pack of claim 1, wherein the plurality of energy storage devices comprises at least one of a plurality of battery cell stacks or a plurality of battery modules.

5. The battery pack of claim 1, wherein the plurality of energy storage devices comprises at new battery cell stacks and new battery modules, or repurposed battery cell stacks and repurposed battery modules.

6. The battery pack of claim 1, further comprising a battery pack bracket that fixes a position of the plurality of energy storage devices in the battery pack housing, wherein the battery pack bracket accommodates at least one of a plurality of shapes, a plurality of sizes or a plurality of orientations of the plurality of energy storage devices.

7. The battery pack of claim 6, wherein the battery pack bracket comprises an adjustable battery pack bracket including a locking mechanism that fixes a configuration the adjustable battery pack bracket.

8. The battery pack of claim 6, wherein the plurality of energy storage devices comprises a plurality of battery cell stacks, and the battery pack bracket accommodates multiple configurations of the plurality of battery cell stacks while maintaining safe operation of the battery pack.

9. The battery pack of claim 6, wherein the plurality of energy storage devices comprises a plurality of battery modules, and the battery pack bracket accommodates multiple configurations of the plurality of battery modules while maintaining safe operation of the battery pack.

10. A method of replacing a first energy storage device of the plurality of energy storage devices in the battery pack of claim 6, the method comprising:
removing the first energy storage device from the battery pack housing;
inserting a second energy storage device into the battery pack housing; and
adjusting the battery pack bracket from a first setting configured accommodate the first energy storage device having a first size, a first shape and a first orientation to a second setting different than the first setting to accommodate the second energy storage device having at least one of a second size different than the first size, a second shape different than the first shape, or a second orientation different than the first orientation.

11. An energy storage system (ESS) unit, comprising:
an ESS unit housing;
a battery pack in the ESS unit housing, comprising:
a battery pack housing;
a plurality of energy storage devices of a plurality of different types located in the battery pack housing; and
a battery management system (BMS) unit electrically coupled to the plurality of energy storage devices and configured to manage an operation of the plurality of energy storage devices; and
an ESS controller communicatively coupled to the BMS unit of the battery pack and configured to control an operation of the ESS unit.

12. The ESS unit of claim 11, wherein the plurality of energy storage devices comprises at least one of new battery cell stacks, new battery modules, repurposed battery cell stacks or repurposed battery modules.

13. The ESS unit of claim 11, further comprising an ESS unit bracket that fixes a position of the battery pack in the ESS unit housing, wherein the ESS unit bracket includes a locking mechanism that fixes a configuration of the ESS unit bracket.

14. The ESS unit of claim 13, wherein the ESS unit bracket comprises an adjustable ESS unit bracket accommodating at least one of a plurality of shapes, a plurality of sizes or a plurality of orientations of the battery pack.

15. The ESS unit of claim 11, further comprising a temperature control system configured to monitor and control a temperature of the ESS unit, wherein the temperature control system is configured to be controlled by the ESS controller.

16. The ESS unit of claim 11, wherein the ESS controller comprises:
electrical devices comprising at least one of electrical relays, DC/DC converters or electrical fuses; and
wiring connecting the electrical devices to the battery pack.

17. The ESS unit of claim 11, wherein the ESS controller comprises a telematics unit communicatively coupled to the BMS unit of the battery pack.

18. The ESS unit of claim 12, wherein the ESS controller comprises an input/output (I/O) port connecting the ESS controller to an inverter connected to at least one of a renewable energy power source or an electrical power grid.

19. A method of replacing a battery pack in an energy storage system (ESS) unit, the method comprising:
providing an ESS unit including an ESS unit bracket set to a first setting to accommodate a first battery pack having a first size, a first shape and a first orientation;
removing the first battery pack from the ESS unit;
inserting a second battery pack into the ESS unit, wherein the second battery pack includes at least one of a second size different than the first size, a second shape different than the first shape, or a second orientation different than the first orientation; and
adjusting the ESS unit bracket from the first setting to a second setting different than the first setting to accommodate the second battery pack.

20. The method of claim 19, further comprising locking the ESS unit bracket into the second setting using a locking mechanism of the ESS unit bracket.
